(19) United States
(12) Patent Application Publication
(10) Pub. No.: US 2007/0248012 A1
(43) Pub. Date: Oct. 25, 2007

(54) Quality of service reporting for a communication device

(75) Inventors: Brian James Glinsman, Oak Hill, VA (US); John William Warner, Sterling, VA (US)

Correspondence Address: TEXAS INSTRUMENTS INCORPORATED, P O BOX 655474, M/S 3999, DALLAS, TX, 75265, US

(73) Assignee: Texas Instruments, Inc.

(21) Appl. No.: 11/411,047

(22) Filed: Apr. 25, 2006

(51) Int. Cl. H04L 12/26

(52) U.S. Cl. 370/232

(57) ABSTRACT

A communication system includes a first communication device, the first communication device including a transceiver that receives information that characterizes quality of service for a second communication device that is remotely located relative to the first communication device with which the first communication device is in communication. The first communication device also includes an analyzer that evaluates the information and reports a quality of service for the second communication device at the first communication device.

### TECHNICAL FIELD

This invention relates to the field of communications, and more specifically, to the field of telecommunications.

### BACKGROUND

In the field of telecommunications, a communication device is typically employed by a first user, hereinafter referred to as the Near End User (NEU). The NEU can typically communicate with one or more second users employing a second communication device, hereinafter referred to as the Far End Users (FEUs). The communication devices could include wired or wireless communication devices.

Most wireless communication devices are mobile stations, such as handheld telephones that are used by pedestrians or individuals traveling in automobiles. A mobile station can contact another mobile station or a fixed position relay station to communicate with other users in a communication system. Typically, a mobile station is allowed to operate as it travels through a variety of geographical regions that can include coverage areas for one or more communication service providers. The geographical area in which communications are exchanged between a wireless communications device and a base station is typically called a coverage area. Often, communication networks are broken up into discrete coverage areas referred to as cells, such as in cellular telephone networks. These cells correspond approximately to geographical regions inside the communication network. As a mobile station or cellular telephone moves through geographical regions it can change cells, communicating through proximate cells as it moves.

The coverage area of a wireless communication system can be limited by a number of parameters. The presence of nearby tall buildings, mountains or hillsides can shadow (block) radio frequency (RF) signals between a mobile station and a communicating base station. These and other structures can also limit coverage by multi-path interference, which corresponds to the arrival of echoed copies of the same communication at two different periods in time. Operator-configurable system parameters can also affect the coverage area. These parameters include the positioning of base station antennas, the selection of which base station communicates with the mobile station and the transmit power levels of the mobile station and the base station. Co-channel interference between multiple mobile stations and base stations, using the same radio frequency in adjoining cells can also limit the coverage area.

In many cases, system parameters, such as antenna orientation, that effect coverage areas are adjusted on a daily basis. Users find that certain so called “dead spots” or locations where communications are frequently dropped or cannot be initiated remain constant. Other “dead spots” may vary as the side effects of optimizations performed in the network. For example, a cell-site antenna may be re-aimed to provide a stronger signal to one coverage area at the expense of a weaker signal in a second coverage area.

Many wireless communication systems generally use digital schemes instead of previously used analog techniques. Generally, these digital systems allow service providers to support more users with the same limited bandwidth. These digital systems also provide new customer services, such as resistance to eavesdropping and fraud, and longer battery life. Digital systems can also provide a more consistent audio quality. With developments in media compression and wireless network infrastructures, media streaming has also become a promising area of technology for many communication systems. However, there are still inherent problems when it comes to the wireless environment, at least partially due to unpredictable factors that effect wireless communications. Such unpredictable factors can include, for example, weather, sudden increases in wireless communication traffic and physical movement of communication devices within communication system.

Areas of wireless communications where such problems are encountered include real-time media applications (including both audio and video streaming), real-time audio applications (such as live music or sports broadcasts), off-line media applications, off-line audio applications and traditional telephone communication. Communication systems can suffer from packet loss and intermittent packet delays. Packet loss and delays may be caused by factors such as network congestion, bit error rates or data overflow at the user's device apart from effects, such as fading, which is an inherent characteristic of wireless networks.

In addition to packet loss, there are other factors that can adversely affect the media received by a user, referred to as a near end user (NEU). The effect of any of these factors on the user experience can vary greatly depending on communication channel conditions, user device characteristics, environmental conditions, voluntary or involuntary events that occur during communication or other influences. One or more of the above-described factors can also affect the Quality of Service (QoS) for the communication device employed by the NEU as well the one or more far end user (FEU), with which the NEU is communicating. The factors are usually applicable to the QoS between the NEU and FEU in a wired or wireless communication system or when a communications session may involve partially wired and partially wireless communication.

In many existing communication systems, and particularly in wireless communication systems, the NEU is provided with an indicia that characterizes the QoS for the communication device employed by the NEU. In the wireless context, for example, this provides the NEU an indication of the QoS being experienced by the NEU due to the communication between the NEU's device and a local base station. However, the NEU generally has no way of knowing the QoS experienced by the FEU without asking the FEU during a communication. What is needed is a communication device that can provide a user detectable indication of the QoS for the communication device employed by the FEU.

### SUMMARY

A communication system including a first communication device, the first communication device including a transceiver that receives information that characterizes quality of service for a second communication device that is remotely located relative to the first communication device with which the first communication device is in communication. The first communication device also includes an analyzer that evaluates the information and reports a quality of service for the second communication device at the first communication device.

A communication system including a base station that provides a first communication device first information that characterizes quality of service for a second communication device. The base station provides the second communication device second information that characterizes quality of service for the first communication device. At least one of the first and second communication devices provides a user detectable indication of a quality of service based for the second and first communication devices, respectively.

A communication system including means for receiving, at a first communication device, information that characterizes quality of service for a second communication device with which the first communication device is in communication. The communication system also includes means for evaluating, at the first communication device, the information. The communication system also includes means for reporting, at the first communication device, a quality of service for the second communication device.

A method for reporting quality metrics in a communication system including receiving, at a first communication device, information that characterizes quality of service for a second communication device with which the first communication device is in communication. The method also includes analyzing, at the first communication device, the information. The method also includes reporting, at the first communication device, a quality of service for the second communication device.

### BRIEF DESCRIPTION OF THE DRAWINGS

FIG. 1 illustrates a block diagram of a communication device in accordance with an aspect of the invention.

FIG. 2 illustrates an example of a data packet that could be transferred in a communication system such as to or from the device illustrated in FIG. 1.

FIG. 3 illustrates another block diagram of a communication device in accordance with an aspect of the present invention.

FIG. 4 illustrates a block diagram of a quality of service subsystem that could be used in a communication device described in FIG. 3.

FIG. 5 illustrates an example of a user interface in a communication device in accordance with an aspect of the invention.

FIG. 6 illustrates an example of a communication system in accordance with an aspect of the invention.

FIG. 7 illustrates a flow diagram of a method in accordance with an aspect of the invention.

### DETAILED DESCRIPTION

The present invention relates to communication systems, and more specifically to the reporting of quality service in communications systems.

In a typical communication session between two or more users, one user can be employing a first communication device to communicate with a second user (or more) employing a second communication device. The first and second users (and the first and second communication devices) can be in different physical locations. Taken from the viewpoint of the first communication device, the user employing the first communication device is referred to as a near end user (NEU). The second user, with whom the NEU is communicating, is referred to as a far end user (FEU). It is to be understood that there can be one or more FEUs (e.g., in a conference call). In the present invention, the first communication device can report one or more user-detectable indication (e.g., visual, audible and/or tactile representation detectable by the NEU) that characterizes a quality of service (QoS) for the second communication device during the communication session of the FEU.

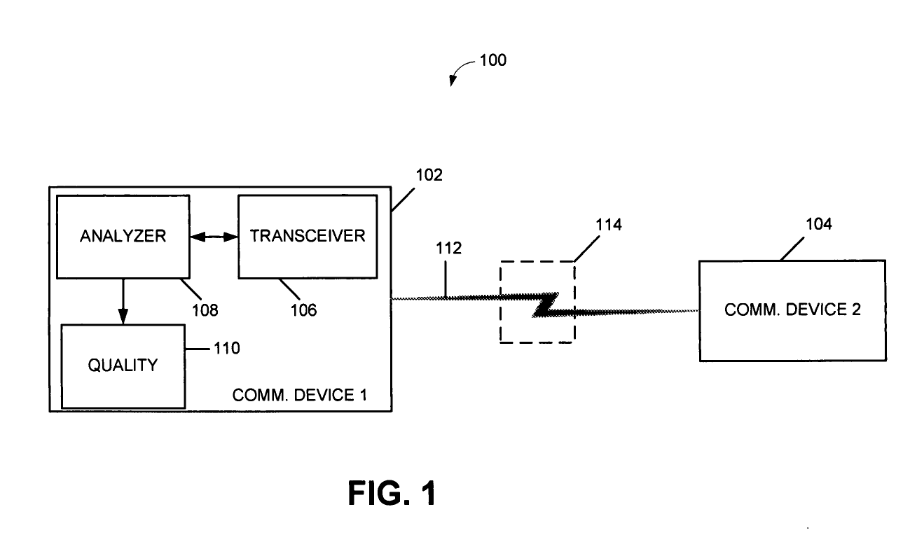

FIG. 1 illustrates a block diagram of a communication system 100 in accordance with an aspect of the invention. The communication system 100 can include a first communication device (COMM. DEVICE 1) 102 and a second communication device (COMM. DEVICE 2) 104. The first and second communication devices 102 and 104 could be implemented, for example, as Internet Protocol (IP) phones employing Voice over IP (VoIP) via the Real Time Control Protocol Extended Reports (RTCP XR) protocol, wireless phones (e.g., Global System for Mobile Communication (GSM) phones or Personal Communication Services (PCS) phones), personal digital assistants (PDAs) or a combination thereof. It is to be understood that the first and second communication devices 102 and 104 could be similar or substantially different types of communication devices. For example, the first and second communication devices 102 and 104 could both be implemented as wireless phones. Alternatively, the first communication device 102 could be implemented as a wireless phone, while the second communication device 104 could be implemented as an IP phone.

The first communication device 102 includes a transceiver 106 that is configured to transmit and receive communications signals over or one or more communication media. The transceiver 106 could be implemented, for example, as a radio frequency (RF) transceiver or a network transceiver (e.g., an Ethernet transceiver). An analyzer 108 can receive information from the transceiver. At least a portion of the information can characterize a QoS for at least the second communication device 104. The information can be generated by the second communication device 104, a base station, a service provider or a combination thereof that can determine the quality of the communication session from the perspective of the second communication device. The analyzer 108 is operative to provide a quality output 110 to describe the QoS for at least the second communication device 104. The analyzer 108 can provide the quality output 110, for example, to memory or to one or more output devices (not shown) so as to render the quality. The analyzer 108 could be implemented, for example, as hardware (e.g., a processor), software (e.g., computer instructions executed on a processor) or combination thereof It is to be understood that the second communication device 104 could also include similar components, but were not included in FIG. 1 for purposes of simplified explanation.

In a typical communication system 100, the first and second communication devices 102 and 104 can communicate over a network, schematically indicated at 114, through a communication link 112. By way of example, the first communication device 102 could initiate a connection request, such as may be activated by dialing a phone number (or other station identifier) associated with the second communication device 1041. In such a case, the second communication device 104 can accept or deny the connection request. If the connection request is accepted, the communication link 112 can be established between the first and second communication devices 102 and 104. The network 114 could include, for example, the Internet, the public switched telephone network (PSTN), a cellular communication network, a private network or a combination thereof The first and second communication devices 102 and 104 can communicate bi-directionally over the communication link 112. After the communication link 112 has been established, an NEU can commence voice communications with an FEU.

As mentioned above, the transceiver 106 can transmit and receive information to and from the second communication device 104 via the communication link 112. As an example, the information is sent and received as an analog signal that encodes digital data packets. The transceiver 106 could be implemented, for example, such that it can convert (e.g. decode) a received analog signal into the corresponding data packets. Those skilled in the art will appreciate that the packet type used to implement the data packet can vary based on the particular network that is implemented to establish the communication link 112 between the first and second communication devices 102 and 104. For example, if the first communication device 102 is implemented as an IP phone, the data packets could be implemented, for example, as Transmission Control Protocol/Internet Protocol (TCP/IP) packets. Alternatively, if the first communication device 102 is implemented as a GSM phone, the data packets could be implemented, for example, as GSM-Mobile Application Protocol (GSM-MAP) packets. The transceiver 106 receives the data packets, and examines the data in the data packets, such as including preprocessing and data extraction. Typically, the data packets can contain information that indicates the type of information at particular fields or the destination for the various encoded and packetized data.

According to an aspect of the present invention, some of the information, namely, information destined for the analyzer 108, can be extracted from the data packets, converted (e.g., decoded) to an appropriate format and forwarded to the analyzer 108. Other information not destined for the analyzer 108 (e.g., voice data and operating parameter data) can be forwarded to other components of the first communication device 102 (not shown). The voice data could include, for example, an encoded audio signal that was sent from the second communication device 104.

The information received by the analyzer 108 could include, for example, data that represents one or more quality metrics that characterize QoS for the second communication device 104. The quality metrics could include, for example, data that characterizes one or more of a signal and/or noise level, packet loss and/or discard rate, packet latency (delay), echo levels or call quality experienced by the second communication device 104. The analyzer 108 receives the quality metric data, evaluates it and determines a QoS value for the second communication device 104 based on the information. The analyzer 108 can provide the calculated QoS value as the quality output 110. The quality output 110 can be employed by an audio or visual subsystem (not shown) of the first communication device 102 to provide the NEU with one or more user-detectable indication that characterizes the quality output 110 for the second communication device 104. As used herein, the term “user-detectable indication” is intended to encompass one or more representations of the quality output 110 that can be perceived by a user (e.g., capable of being perceived by any one or more senses: touch, sight, smell, taste and sound). Additionally or alternatively, the quality output 110 could be stored, for example, in memory. The transceiver 106 and/or the analyzer 108 can thus operate as means for receiving, at the first communication device 102, information or data that characterizes the QoS for the second communication device 104 with which communication device is in communication. Additionally, the quality output 110 or the audio/video subsystem that uses the quality output can correspond to means for reporting, at the first communication device 102, a QoS for the second communication device 104.

It is to be understood that the first communication device 102 may receive updated quality metrics intermittently or periodically. The analyzer 108 can recalculate the QoS output 110 based on the updated quality metrics (e.g., intermittently or periodically). The quality metric data could be provided from the second communication device 104. Additionally or alternatively, the quality metric data could be provided by an agent of the network 114 (e.g., a communications service provider or a base station) and inserted into the communication stream from the second device 104.

The analyzer 108 can also calculate a second QoS value that characterizes the QoS experienced by the first communication device 102 of the NEU. The analyzer 108 (or associated components) could measure parameters, such as signal and/or noise level, packet loss and/or discard rate, packet latency (delay), echo levels or call quality at the second communication device 104 to derive the second QoS value. This second QoS value could also be provided as a second via the quality output 110. The analyzer 108 could be programmed and/or configured to report the second quality output to associated audio and/or visual subsystems to inform the NEU of the second QoS. Accordingly, the first communication device 102 could be configured to provide two separate user-detectable indications: one that indicates the QoS for the second communication device 104, and another that indicates the QoS for the first communication device 102.

Additionally or alternatively, the analyzer 108 could be implemented to calculate an aggregate quality value based on the QoS determined for the second communication device 104 and the second QoS value for the first communication device 102. The analyzer 108 can provide the aggregate quality value via the quality output 110. The aggregate quality output can, in turn, be provided to the associated audio or visual subsystems to report to the NEU an indication of aggregate quality (e.g., that characterizes the overall quality of a communication session).

The analyzer 108 could also provide one or more of the determined quality metrics to the transceiver 106 that characterizes the calculated QoS value for the first communication device 102 of the NEU. The transceiver 106 could, in turn, provide the second communication device 104 of the FEU with the at least one quality metric via the communication link 112. Other communication resources involved in the communication session (e.g., base station or central system or network hub) can also receive and utilize the QoS metrics sent by the first communication device 102. The analyzer 108, the transceiver 106, and/or the other communication resources (taken individually or collectively) can correspond to means for providing the second communication device 104 with second QoS data that characterizes one or more aspects of the QoS for the first communication device 102. The second communication device 104 can utilize the received QoS data to report on the QoS of the first communication device 102, such as providing a user-detectable indication thereof to the FEU.

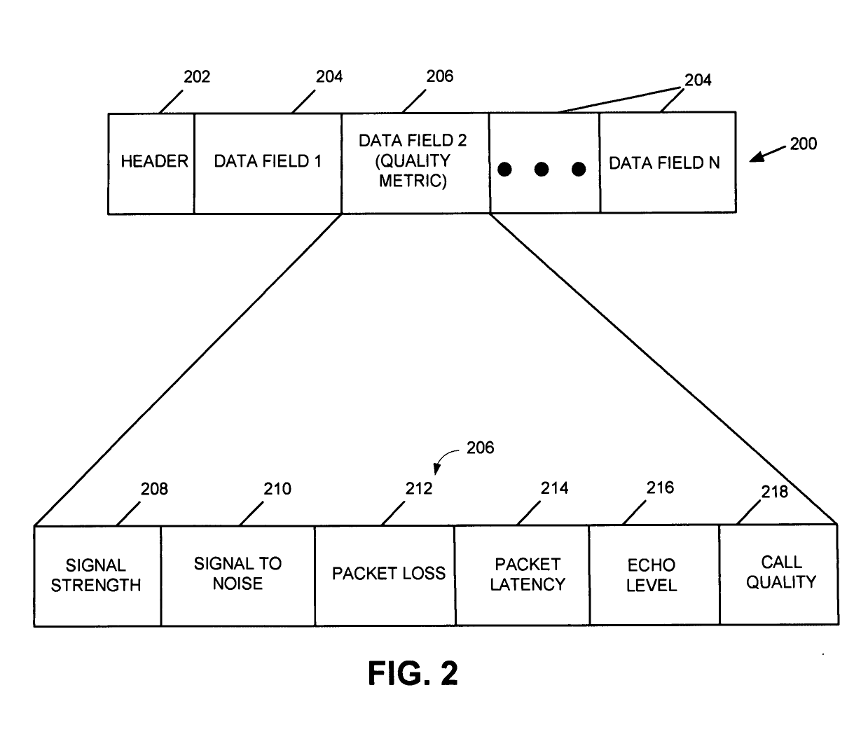

FIG. 2 illustrates an example of a data packet 200 that could be transferred between the first communication device 102 and the second communication device 104 illustrated in FIG. 1. The data packet 200 includes a header 202, and N number of other data fields 204, wherein N is an integer greater than or equal to one.

By way of example, the data packet 200 could be implemented as a TCP/IP data packet 200. In such an implementation, at least one communication device could be implemented as an IP phone employing the RTCP XR protocol. Typically, a TCP/IP data packet 200 implemented by an IP phone has a sending communication device (hereinafter “origin”) and a receiving communication device (hereinafter “destination”). The header 202 of the TCP/IP data packet 200, for example, can indicate the destination (e.g., the IP address of the destination) and the origin (e.g., the IP address of the origin). Each data field 204 of the TCP/IP data packet could include one or more parts of information. As an example, DATA FIELD 1 could include a digitally encoded audio signal (e.g., the voice data). One of the data fields 204 could information, such as one or more quality metrics defined by the RTCP XR protocol. For example, the second data field (DATA FIELD 2) 206 could include data-subfields (e.g., one or more bits) that characterize one or more of the origin's signal strength 208, signal to noise level 210, packet loss 212 (or discard rate), packet latency (delay) 214, echo level 216 or call quality 218. Other types of information can also be provided in DATA FIELD 2.

It is to be understood that the data packet 200 illustrated in FIG. 2 is provided by way of example and not limitation. Other data packets with a substantially different structure could be employed to implement an embodiment of the present invention. For instance, the quality metric data field could be sent in the header 202, a footer or it may be distributed among two or more separate fields 202, 204 and/or 206, which may be further provided over any number of one or more frames.

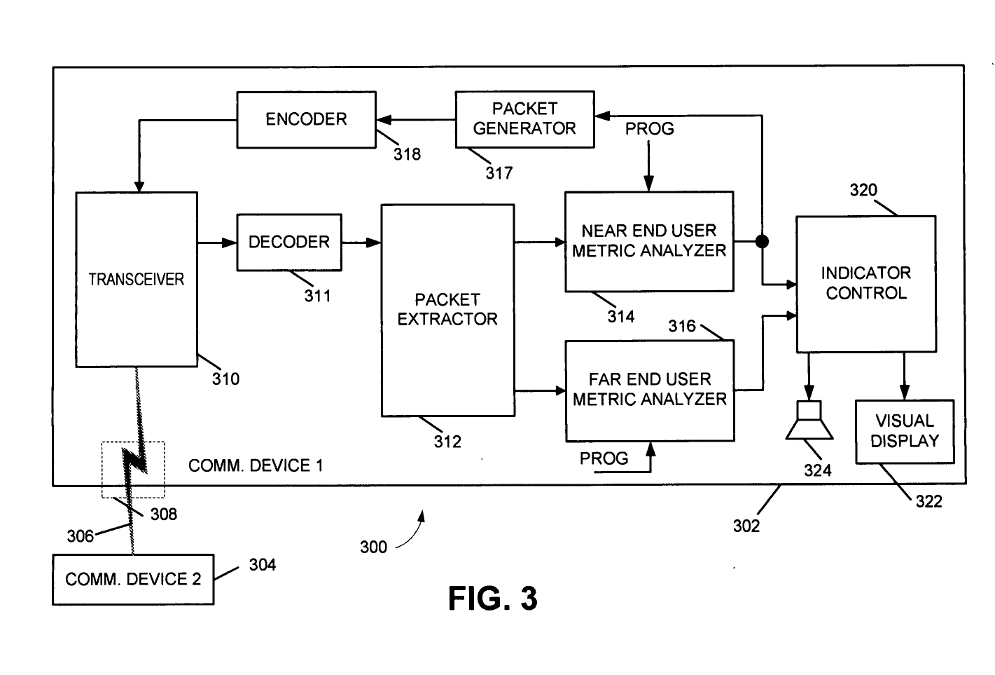

FIG. 3 illustrates another block diagram of a communication system 300 in accordance with an aspect of the present invention. The communication system 300 includes a first communication device (COMM. DEVICE 1) 302 and a second communication device (COMM. DEVICE 2) 304. The first communication device 302 and the second communication device 304, for example, communicate with each other over a communication link 306. The communication link 306 could be established over a network, shown schematically at 308. The communication link 306 further may include or more communication channels (wired and/or wireless) established over the network 308. The network 308 can include the Internet, the PSTN, a cellular communication network, a private network or any a combination thereof, which may be offered by one or more service providers via corresponding communication resources (e.g., wireless base stations, a network hubs or servers, routers, and the like). It is to be understood that the first communication device 302 can be similar or substantially different from the second communication device 304.

The first communication device 302 includes a transceiver 310 that can send and receive signals through the communication link 306. Typically, the signals sent and received by the transceiver 310 can be implemented as analog signals that encode digital data. Alternatively, the signals can be sent through the communication link 306 as digital signals. The transceiver 310 could be implemented, for example, as including an antenna and one or more amplifiers and filters for transmitting and receiving the signals. Alternatively, the transceiver 310 could be implemented to include a network interface device (e.g., an Ethernet transceiver).

The transceiver 310 can provide received signals to a decoder 311. The decoder 311 can be programmed and/or configured to convert (e.g., decode) the received signals into a format that is readable by the packet extractor 312 (e.g., one or more data packets). As an example, the decoder 311 could receive a radio frequency (RF) signal, convert the RF signal to a digital signal and provide the digital signal to the packet extractor 312. The digital signal could be provided to the packet extractor 312 as a series of data packets. The packet extractor 312 receives the data packets, and examines data in the data packets. The packet extractor 312 determines the destination of the data packets and routes the data packets to the appropriate destination, such as the NEU analyzer 314 and the FEU analyzer 316. Additionally, the packet extractor 312 could route the data packets to other components of the first communication device 302 that have been omitted for purposes of simplification of explanation. The data packets routed to the other components could include, for example, voice data. The voice data could be, for example, in the form of an encoded audio signal.

The packet extractor 312 can be configured and/or programmed to extract data from the one or more data packets and provide the data to the appropriate component of the first communication device 304, such as an NEU metric analyzer 314 (“NEU analyzer”) and an FEU metric analyzer 316 (“FEU analyzer”). The packet extractor 312 could be implemented, for example, as hardware (e.g., a processor), software (e.g., computer executable instructions running on a processor) or a combination thereof programmed and/or configured to extract the data including the quality metric data.

The FEU analyzer 316 and the NEU analyzer 314 can analyze the data provided by the packet extractor 312 and provide corresponding quality output data. The data from the packet extractor 312 can include quality metric data provided from the second communication device 304 or from the network 308 (e.g., a communication service provider or a base station). The quality metric data can characterizes the QoS experienced by the second communication device 304 of the FEU. The information could be formatted as a data structure having one or more data fields containing one or more QoS metric. For example, the one or more QoS metric can include, for example, information that characterizes at least one of a signal strength and/or noise level, packet loss and/or discard rate, packet latency (delay), echo levels or call quality experienced by the second communication device 304 of the FEU. The FEU analyzer 316, for example, can calculate a first QoS value based on the QoS metric data received by the FEU analyzer 316. The FEU analyzer 316 can provide the first QoS value to an indicator control 320.

The indicator control 320 is operative to provide one or more output signals for driving a visual display 322 and/or a loudspeaker 324 for providing the user-detectable indication of QoS for the FEU. The indicator control 320 could be implemented, for example, as hardware (e.g., a processor), software (e.g., computer executable instructions running on a processor) or a combination thereof for controlling the user-detectable indication of QoS that is provided at the first communication device 302. For instance, the indicator control 320 can include an amplifier for driving the loudspeaker 324 to provide an audible tone and/or recorded voice message that is played for the NEU. The audible indication can vary based on the first QoS value, such as providing a different tone over a range of QoS values or by adjusting the audio based on the QoS value relative to one or more predetermined threshold values. Alternatively or additionally, the indicator control can provide an output signal to the visual display 322 to provide a graphical and/or textual representation based on the first QoS value for the FEU. The visual display 322 could be implemented, for example, as a liquid crystal display (LCD), plasma display, cathode ray tube (CRT), or other types of display technology known or yet to be developed. For example, the indicator control 320 can control the visual display 322 to report the FEU's QoS as a graphical element having a plurality of bars that successively increase in number and length as a function of the QoS value provided by the FEU analyzer 316. Thus, the indicator control 320, the loudspeaker 324 and/or the visual display 322 (individually or in combination) can correspond to means for providing at least one of an audio indication and a visual indication of a QoS for the FEU.

It is to be understood that the first communication device 302 can establish a communication link 306 with two or more communication devices (e.g., a conference call). In such an implementation, the first communication device 302 could be configured such that the FEU analyzer 316 can provide a QoS value for the two or more communication devices that are part of the communication session. In multi-party communication, the QoS value might include separate values for each communication device, such that separate user-detectable indications (e.g., audio and/or video) can be provided for the QoS of each FEU based on the respective output values. Alternatively or additionally, the FEU analyzer can provide the QoS output value to the indicator control so as to provide an aggregate representation of the QoS experience by the set of FEUs in the communication session.

The NEU analyzer 314 can receive information from the packet extractor 312 that can be used to calculate at least one QoS metric that characterizes the QoS for the first communication device 302. The information from the packet extractor 312 could include, for example, raw data (e.g., control information from a base station) that characterizes signals sent and received by the transceiver 310 that can be used in a quantitative analysis. The NEU analyzer 314 can perform quantitative analysis to assess one or more quantifiable parameters that characterize the QoS experienced by the first communication device 302 of the NEU. The quantifiable communication quality parameters can include, for example, echo level, packet transit times, packet loss rate and signal and/or noise strength. The NEU analyzer 314 can generate at least one QoS metric and provide a corresponding second QoS value for the first communication device 302. The at least one QoS metric could be implemented as, for example, information that characterizes one or more communication quality parameters first communication device 302 of the NEU. The second QoS value can correspond to a value that characterizes an aggregation of the one or more quality metrics, such as described herein.

Additionally or alternatively, the NEU analyzer 314 could provide the second QoS value to the indicator control 320. The indicator control 320, for example, receives the second QoS value and provides an output signal to the loudspeaker 324 and/or to the visual display 322. In response to the output signal, the loudspeaker 324 and/or the visual display 322 could provide the NEU with at least one user-detectable indication of the first communication device 302. The user-detectable indication could be the same type or different from that discussed above with respect to the QoS experienced by the second communication device 304 of the FEU. Thus, the communication device 302 can keep the NEU informed of the service quality for both the FEU and the NEU.

It is to be understood that the NEU analyzer 314 and the FEU 316 analyzer could provide the indicator control 320 with the first and second QoS values intermittently or periodically, such that the QoS information can reflect variations in QoS over time. Additionally or alternatively, the user-detectable indication could be updated if a QoS value crosses one or more of threshold levels (e.g., such as providing a warning that the QoS has dropped below a certain level).

Optionally, the first communication device 302 could receive information that describes the physical location of the first communication device 302. The first communication device 302 can calculate its physical location, for example, by satellite triangulation such as a global positioning system (GPS) by or a cellular base station triangulation. Alternatively, the location information can be determined by a service provider.

The NEU analyzer 314 can also provide the at least one QoS metric (or the second QoS value) and the optional location data to a packet generator 317. The packet generator 317 can convert the at least one QoS metric and location information into one or more data packets along with other data (e.g., voice data and control information). The packet generator 317 can provide the one or more data packets to an encoder 318. The encoder 318 can convert (e.g., encode) the one or more data packets into a form that can be transmitted by the transceiver 310. For example, the packet generator 317 could provide the at least one QoS metric and location information into one or more data fields of a data packet or over a series of multiple packets. The encoder 318 converts the data packet into an encoded signal, which is provided to the transceiver 310. The transceiver 310 transmits the at least one QoS metric and (optional) location information via a corresponding signal (e.g., an RF signal) through the communication link 306 to the second communication device 304.

As mentioned above, the NEU analyzer 314 and the FEU analyzer 316 can be programmable by the NEU, such as by a PROG input signal. The NEU can program the NEU analyzer and the FEU analyzer by, for example, operating a corresponding part of a user-interface, such as may be provided as a graphical-user interface via the visual display 322 (e.g., as one or more menus). The NEU, for example, could change the parameters for calculating the QoS values. Additionally or alternatively, the NEU could also enable or disable the calculation of the QoS values and/or enable or disable the providing of the QoS indication. The NEU could change how the QoS is represented at the first communication device 302 (e.g., change from audio to visual indicia) or change the type of display or the display format. Those skilled in the art will understand other ways that the NEU or a service provider can program the user-detectable indication of the QoS provided by the communication device 302 based on the teaching contained herein.

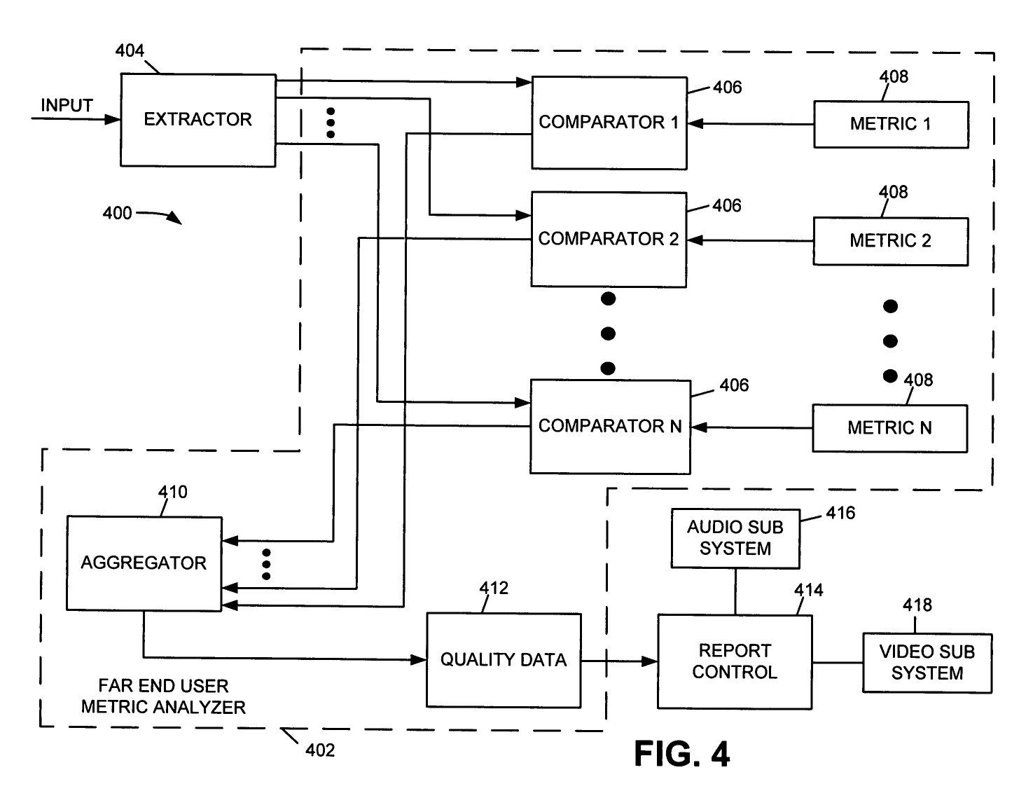

FIG. 4 illustrates an example block diagram of a QoS subsystem 400 that can be implemented according to an aspect of the present invention. The subsystem 400 includes an FEU analyzer 402 that could be used in a communication device, such as described in FIG. 3. An extractor 404 can extract one or more data fields (or subfields) from an input data stream, such as may correspond to packet data received over a communication link. The FEU analyzer 402 could be implemented as hardware, software or a combination thereof programmed and/or configured to analyze the QoS based on quality metric data from the extractor 404.

The FEU analyzer 402 can include N number of comparators 406, wherein N is an integer greater than or equal to one corresponding to the number of different quality metrics or communication quality parameters being analyzed. Each of the N number of comparators 406 can compare QoS data from the extractor 404 with reference metric data provide by a corresponding one of N number of metric references (METRIC 1 to METRIC N) 408. The comparators 406 provide the results of the comparison to an aggregator 410. The aggregator 410 can provide, for example, quality data 412 that characterizes a QoS based on the parameters compared by the respective comparators 406.

By way of further example, the extractor 404 receives an input signal such as a digital signal that includes one or more data packets. The data packets can include, for example, N parts of information that characterize a QoS experienced by a remote communication device used by an FEU. Each of the N parts (e.g., subfields) of information can include a value that corresponds to a given aspect of a communication session that corresponds to one of the metric references 408. For example, one part of the information could characterize a communication device's signal strength. Additionally, metric reference 1 (METRIC 1) 408 could include one or more reference values that represents a threshold for a communication device's signal strength. COMPARATOR 1 could compare the part of the received information characterizing signal strength with the one or more reference values and provide corresponding output value. The output value thus characterizes the signal strength of the communication device. For example, if the output value represents a characteristic for the strength of signal for the communication device, the output value could, for example, represent one of a “poor” signal strength, a “fair” signal strength, a “good” signal strength or an “excellent” signal strength. The granularity of information conveyed by the output value can vary according to the number of bits used to represent the output value. Similarly, COMPARATORS 2-N could compare other parts of the information with reference values that could represent, for example, the communication device's packet loss, packet latency, echo levels or other aspects of call quality. Each of the other COMPARATORS 2-N also provides an output value that that represents the respective characteristic of the QoS experienced by the communication device.

The aggregator 410 thus can receive a plurality of output values from the N comparators 406. The aggregator 410 calculates an aggregate QoS value based on the plurality of output values. The aggregate QoS value could represent a quantitative analysis of the plurality of output values that characterizes an overall QoS experienced by the communication device. It is to be understood that certain comparator output values could be weighed differently (more or less) than others, such that the aggregate QoS value does not necessarily represent an “average” of the plurality of output values. The weight given to each of the respective output values could be programmed (e.g., by user at the communication device through user menus or by control information provided by a service provider) such as according to the relative importance of the parameters being analyzed to the QoS. The aggregator can provide the aggregate QoS value as quality data 412. The quality data 412 can be stored in memory. The quality data 412 is provided to the report control 414.

The report control 414 can control an audio subsystem 416 and/or a video subsystem 418, such as shown in the example of FIG. 4, to provide one or more user-detectable of the QoS value. The audio subsystem 416 could include, for example, an amplifier and a loudspeaker. The video subsystem 418 could include, for example, a video driver and a visual display (e.g., an LCD screen). As an example, the indicia could be implemented as a graphical element having a plurality of bars that successively increase in length, wherein the total number of bars represents the QoS value. Additionally or alternatively, the indicia could be implemented as an audible tone and/or recorded voice message that is played based on the QoS value relative to one or more threshold values. Those skilled in the art may appreciate other types of quality indicators that may be utilized to report QoS based on the teachings herein.

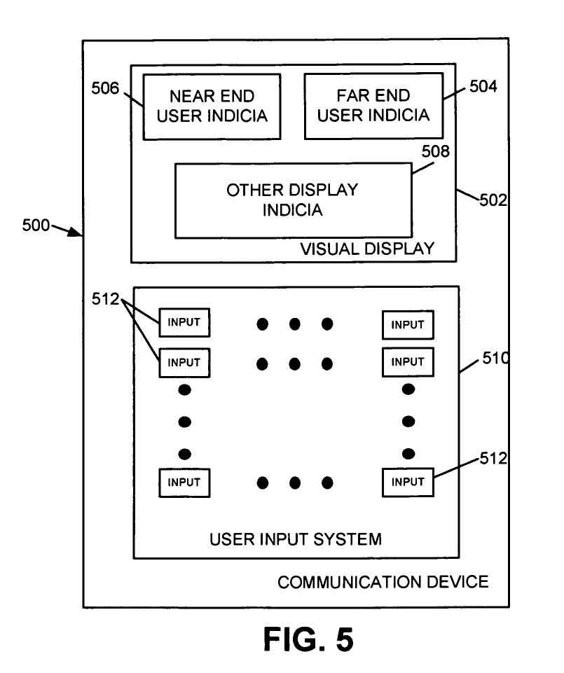

FIG. 5 illustrates a diagrammatic representation of an exterior of one type of communication device 500 that can be utilized in accordance with an aspect of the invention. In The communication device 500 includes a visual display 502, such as an LCD display or other type of display device. The visual display 502 could be driven, for example, by a video or display driver that can provide corresponding signals to cause the display to present graphical elements and/or text to the user. As described herein, the one or more graphical elements can include, for example, an FEU indicia 504, an NEU indicia 506 and other display indicia 508. As an example, the FEU indicia 504 could be implemented, for example, as a graphical element having a plurality of bars that can vary in number and length as a function of the QoS value. The NEU indicia 506 could be implemented similarly or differently from the FEU indicia 504. The other display indicia 508 could include, for example, one or more user menus, pictures, connection information or a combination thereof, which may vary based on user inputs.

The device also includes a user input system 510 that provides a man-machine interface (MMI) for the communication device 500. The user input system can include one or more user input components (e.g., corresponding to actuatable switches) 512 that can be physically activated by the NEU. The one or more switches 512 could be implemented, for example, as a numeric key pad, alpha-numeric keyboard, a touch screen, knobs, dials and the like or a combination thereof Additionally, the visual display 502 can be implemented as including a user-input device, such as touch screen, which form parts of the user-input system 510. Typically, the NEU can employ the user input system 510 to interact with the communication device. For example, the user input system 510 can be operative to control the user menus and/or the connection information that are presented to the visual display 502.

By way of example, during a communication session NEU via is established between the communication device and at least one other communication device 500, the visual display 502 can provide the NEU with the FEU indicia 504. The visual display 502 can also provide the NEU with the NEU indicia 506. The communication device 500 can be configured such that the FEU indicia 504 and the NEU indicia 506 can be updated periodically and/or intermittently, corresponding to an updating of the corresponding QoS value. Typically, the FEU indicia 504 can be updated during the session until the communication link is severed (e.g., disconnected). Since the NEU is provided an indication of the FEU's QoS, the NEU can use such information to determine that a communication session is degrading. As a result, the NEU can leverage this information, for example, to make alternative communication arrangements with the FEU in advance of the call being dropped.

As mentioned above, the other display indicia 508 can be used to provide one or more user menus that allow the user to enable or disable the displaying of the NEU indicia 506 and/or the FEU indicia 504. Additionally or alternatively, the one or more user menus could allow the NEU to program the communication device 500, such that an aggregate QoS indicia is provided, such as described herein. Further still, the one or more user menus could allow the NEU to change the type of indicia provided to the NEU, such as changing the indicia from a visual indicia to an audio and/or tactile indicia.

It is to be understood that the user interface illustrated in FIG. 5 is provided by way of example and not limitation. Other user interfaces and types of display elements with a substantially different structure could be employed to implement other embodiments of the present invention.

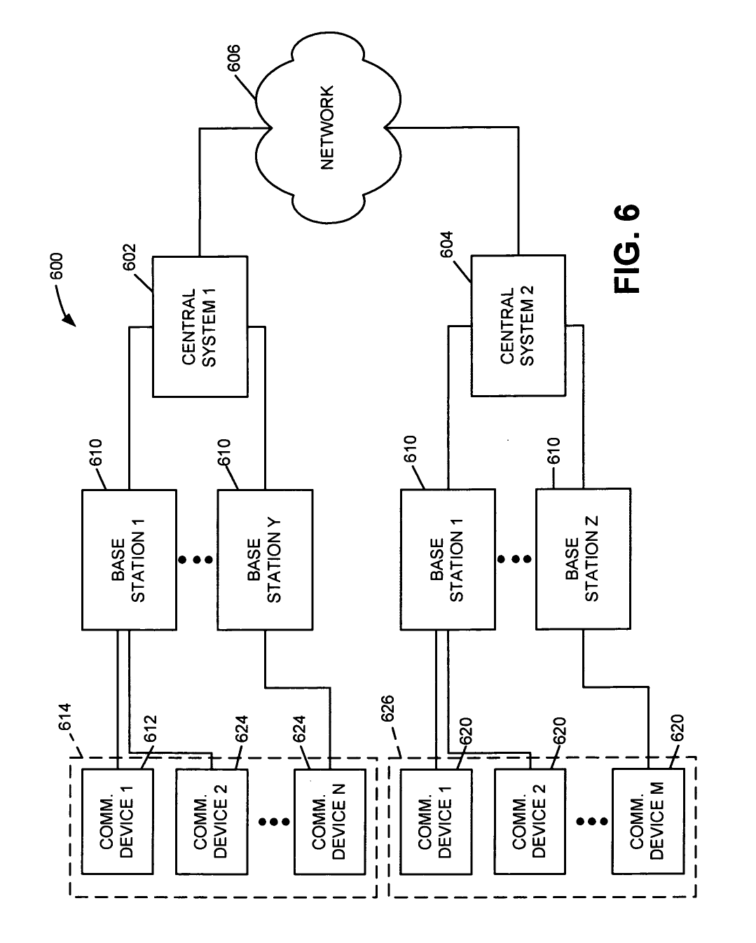

FIG. 6 illustrates an example of a communication system 600 that may be implemented in accordance with an aspect of the invention. The communication system 600 can include central systems 602 and 604 (CENTRAL SYSTEMS 1 AND 2). CENTRAL SYSTEM 1 and CENTRAL SYSTEM 2 could be, for example, IP phone service providers, wireless (e.g., digital cellular) telephone service providers, a land line telephone service providers or a combination thereof Typically, the CENTRAL SYSTEM 1 and CENTRAL SYSTEM 2 can be connected together via one or more networks, indicated diagrammatically at 606. The one or more networks 606, for example, include the Internet, the PSTN, a cellular communication system, a private network or a combination thereof Each of the central systems 602 and 604 can be considered part of a larger network that includes the network 606.

CENTRAL SYSTEM 1 can be connected to Y number of base stations 608, wherein Y is an integer greater than or equal to one. Each base station 608 could be implemented, for example, as one or more access points (e.g., network antennas and routers). The base stations 608 can be connected to N number of communication devices 612, wherein N is an integer greater than or equal to one. The coverage area serviced by the base stations 608 is schematically indicated at 614. Similarly, CENTRAL SYSTEM 2 can be connected to Z number of base stations 610, wherein Z is an integer greater than or equal to one. The base stations 610 associated with CENTRAL SYSTEM 2 can be connected to M number of communication devices 620, wherein M is an integer greater than or equal to one, in an associated coverage area 626.

In a typical communication system, each communication device 612 and 620 can establish a communication link to one or more other communication devices (which may or may not be part of the same central system). The communication link can typically include one or more communication channels that can be wired or wireless through the network 606. During a communication session, the communication devices 612, 620 can provide signals that include QoS data characterizes at least one some of the QoS experienced by the corresponding communication device, such as described herein. Additionally or alternatively, a base station 610 associated with a communication device 624 can determine some or all of the QoS data based on communication parameters. Additionally, the communication devices 624 can provide location data that indicates the physical location of the communication devices 624. By way of example, if a communication link is established between a pair of communication devices, the communication devices can be configured such that each of the first and second communication devices can report on the QoS for the FEU, such as described herein.

CENTRAL SYSTEM 1 and CENTRAL SYSTEM 2 can be configured such that the associated plurality of base stations 608 and 610, respectively, can extract QoS data that is sent between communication devices 624. The one or more base stations can thus provide means for receiving first and second information that is provided by at least the communication devices. Additionally or alternatively, the base station 610 can determine and/or calculate a QoS value based on signals received from the communication devices 612 and 620. The base stations 608 and 610 can also be configured to extract the location data provided by the communication devices. The base station 608 can provide the QoS data and the location data for respective communication devices to CENTRAL SYSTEM 1.

As an example, CENTRAL SYSTEM 1 can employ the QoS data and the location data to develop a correlation between a communication device's 624 QoS and its physical location within each service area (e.g., cell) within the coverage area 614 of the central system. Thus, CENTRAL SYSTEM 1 can report a QoS for the communication devices 612 within its coverage area 614. For example, if CENTRAL SYSTEM 1 receives QoS data and location data for a sufficient number of communication devices 612 in a specific geographical area, CENTRAL SYSTEM 1 can determine an expected QoS for the specific area (e.g., through a data mining process). Accordingly, CENTRAL SYSTEM 1 could determine if one or more adjustments may be useful to enhance QoS for a particular service area. The adjustments could include, for example, changing power levels at one or more of the base stations 608, adjusting the orientation of one or more antennas at one or more of the base stations or other communication parameters that can alter performance. CENTRAL SYSTEM 1 may also develop a coverage map that can indicate the expected QoS for the plurality of specific locations based on the QoS data. Alternatively, or additionally, similar calculations and adjustments can be implemented by one or more base stations 608. The base stations 610 and/or CENTRAL SYSTEM 602 can thus provide means for evaluating and generating information that characterizes the QoS for at least one of the first and second communication devices 626 and 628 as described herein. CENTRAL SYSTEM 2 can operate in a manner substantially similar to CENTRAL SYSTEM 1.

It is to be understood that the different central systems 602 and 604 can optionally share QoS data. The sharing of the data, for example, can also allow communication devices 624 to report a QoS for FEU communication devices that are associated with different central communication systems (e.g., cross-carrier or cross-network information). QoS information transferred between different central systems would typically need to be formatted appropriately, such as according to a common standard or be translated between standards implemented by different respective service providers.

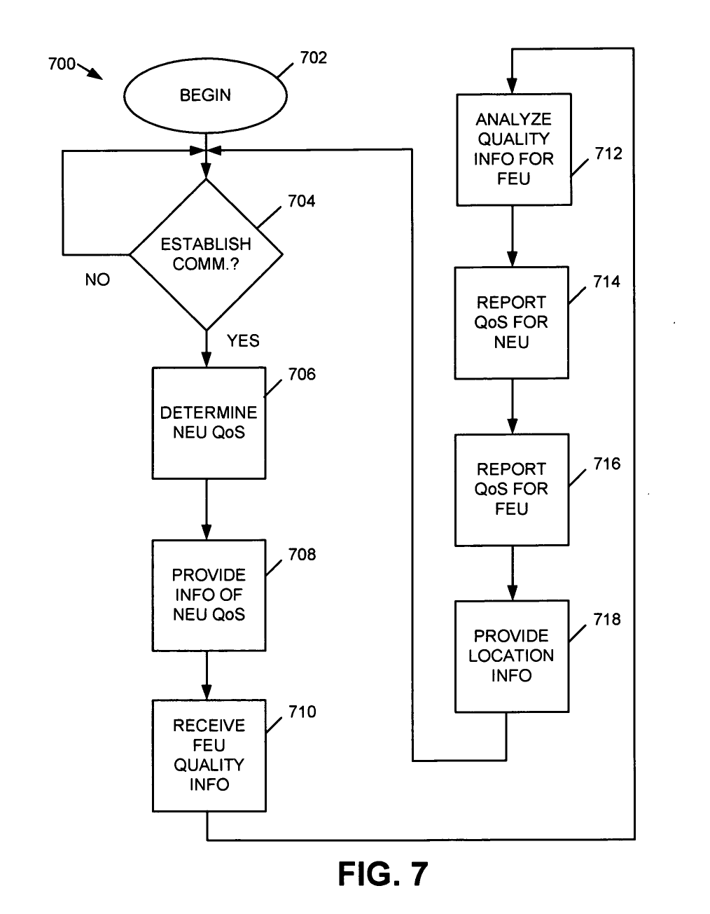

FIG. 7 illustrates a flow diagram of a method 700 in accordance with an aspect of the invention. The method 700 begins at 702, such as by activating a first communication device (e.g., powering on). The first communication device could be implemented, for example, as an IP phone, a wireless phone (e.g., a digital cellular phone) or a PDA. The method 700 proceeds from 702 to 704.

At 704, a determination is made as to whether a communication link is established between the first communication device and a second communication device. A communication link can be established, for example, by providing one or more communication channels that allows (bi-directional) communication between the first and second communication devices. The one or more communication channels could include, for example, a wired channel or a wireless channel.

Typically, the communication link can be established through the request of one of the first and second communication devices and acceptance of the request by the other communication device. Typically, if a communication link is established, an NEU can commence voice communication with an FEU, such as described herein If the determination at 704 is indicates that communication has been established (YES), the method 700 proceeds from 704 to 706. If no communication is established (NO), the method can loop at 704 so long as the device remained powered ON.

At 706, the first communication device determines a QoS value experienced by the NEU, which is referred to as the NEU QoS value. The NEU QoS value could be calculated from, for example, an aggregate evaluation of one or more of the first communication device's signal strength and/or noise level, packet loss and/or discard rate, packet latency (delay), echo levels, call quality or other communication parameters. The method 700 proceeds from 706 to 708. At 708, the first communication device provides information that characterizes the first communication device's QoS, as determined at 706. The method 700 proceeds from 708 to 710.

At 710, the first communication device receives information that characterizes the QoS experienced by an FEU, which is referred to as the FEU quality information. The FEU quality information, for example, can be encoded into one or more data packets, which can be decoded and extracted by the first communication device from a received input signal. The FEU quality information could include one or more of the second communication device's signal strength and/or noise level, packet loss and/or discard rate, packet latency (delay), echo levels or call quality. The method 700 proceeds from 710 to 712 in which the FEU quality information is analyzed and a QoS value is determined based FEU quality information (hereinafter, “FEU QoS value”). The method 700 proceeds from 712 to 714.

At 714, the first communication device reports the NEU QoS value. The report can include the first communication device providing a user-detectable indication that characterizes the NEU QoS value. The user-detectable indication could be implemented, for example, an audible tone, and/or a visual element and/or a tactile function (e.g., vibration). The method 700 proceeds from 714 to 716. At 716, the first communication device reports the FEU QoS value which can include providing an indicia that characterizes the FEU QoS value. The method 700 proceeds from 716 to optional 718 or to 704.

At 718, the first communication device can provide location information to a communication service provider. The location information could be determined for the communication device based on information provided by, for example, a satellite triangulation system, such as GPS system, and/or a base station triangulation system. The communication service provider could extract the location information, along with the NEU quality information to evaluate the QoS for a specific area (e.g., coverage area). The method 700 proceeds from 718 to 704, in which the process can repeat, until the communication session ends, by serving the communication link.

It is to be understood that although the process 700 is shown as a serial process, one or more of the functions in the process can be performed concurrently (e.g., through parallel processing) and that one or more of the functions can be performed in a different sequence than illustrated. It is to be further understood that one or more of the functions in process 700 could be repeated multiple times such as for updating QoS information that is being reported. Additionally, the process has been described from the perspective of the first communication device. The second communication device could also perform a similar process during communication with the first communication device.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A communication system comprising:
a first communication device, the first communication device comprising:
a transceiver that receives information that characterizes quality of service for a second communication device that is remotely located relative to the first communication device with which the first communication device is in communication; and
an analyzer that evaluates the information and reports a quality of service for the second communication device at the first communication device.

2. The communication system of claim 1, wherein the analyzer is a first analyzer and the first communication device further comprises a second analyzer that determines a second quality of service for the first communication device based on at least one quality metric evaluated by the second analyzer, and the second analyzer being configured to report the second quality of service.

3. The communication system of claim 1, wherein the first communication device further comprises a display that provides a visual indication of the quality of service for the second communication device based on the quality of service reported by the analyzer for the second communication device.

4. The communication system of claim 1, wherein the first communication device further comprises a loudspeaker that provides an audio indication of the quality of service for the second communication device based on the quality of service reported by the analyzer for the second communication device.

5. The communication system of claim 1, further comprising the second communication device, wherein the second communication device receives information that characterizes a quality of service for the first communication device, the second communication device further comprises an analyzer that evaluates the information and reports a quality of service for the first communication device at the second communication device.

6. The communication system of claim 1, wherein the quality of service reported by the first communication device indicates the quality of service for the second communication device based on at least one of a signal strength, a signal to noise ratio, signal delay, data loss and echo level for the second communication device.

7. The communication system of claim 1,
wherein the first communication device provides information that characterizes quality of service for the first communication device; and
the communication system further comprises a base station that receives the information transmitted by the first communication device, and provides the information provided by the first communication device to the second communication device.

8. The communication system of claim 7, wherein:
the second communication device provides the information that characterizes the quality of service for the second communication device; and
the first and second communication devices provide information to the base station that indicates a physical location of the corresponding communication device.

9. The communication system of claim 1, wherein the analyzer further comprises a plurality of comparators, wherein each of the plurality of comparators compares at least part of the information with a corresponding reference metric value and provides results of the comparisons to an aggregator that determines the quality of service for the second communication device based on the results of the comparisons.

10. A communication system comprising:
a base station that provides a first communication device first information that characterizes quality of service for a second communication device;
the base station providing the second communication device second information that characterizes quality of service for the first communication device; and
at least one of the first and second communication devices providing a user-detectable indication of a quality of service for the second and first communication devices, respectively based on the second and first information, respectively.

11. The communication system of claim 10, the first and second communication devices providing the base station with information that indicates a physical location of the corresponding communication device, wherein the base station evaluates and generates information that characterizes a quality of service for a coverage supported by the base station the first and second communication devices based on the first and second information and the physical location information.

12. The communication system of claim 11, the base station reporting a quality of service based on the first and second information and the information that indicates the physical location of the first and second communication devices.

13. The communication system of claim 10, wherein the user-detectable quality of service provided by the first and second communication devices is determined based on at least one of a signal strength, a signal to noise ratio, signal delay, data loss and echo level for the second communication device and the first communication device, respectively.

14. A communication system comprising:
means for receiving, at a first communication device, information that characterizes quality of service for a second communication device with which the first communication device is in communication;
means for evaluating, at the first communication device, the information; and
means for reporting, at the first communication device, a quality of service for the second communication device.

15. The communication system of claim 14, wherein the means for reporting further comprises means for providing at least one of an audio output and a visual output indicative of the quality of service.

16. The communication system of claim 14, wherein the information is first information and the communication system further comprises:
means for providing, to the second communication device, second information that characterizes a quality of service for the first communication device;
means for receiving, at the second communication device, the second information;
means for evaluating, at the second communication device, the second information; and
means for reporting, at the second communication device, the quality of service for the first communication device.

17. The communication system of claim 16, further comprising
means for receiving, at a base station, the first and second information; and
means for providing, from the base station, the second and first information to the second and first communication devices, respectively.

18. The system of claim 16, further comprising means for providing, from at least one of the first and second communication devices to the base station, information that indicates a physical location of at the least one of the first and second communication devices.

19. The system of claim 18, further comprising means for evaluating and generating, at the base station, information that characterizes a quality of service for a coverage area supported by the base station based on at least the first and second information and the information that indicates the physical location of at least one of the first and second communication devices.

20. A method for reporting quality metrics in a communication system, the method comprising:
receiving, at a first communication device, information that characterizes quality of service for a second communication device with which the first communication device is in communication;
analyzing, at the first communication device, the information; and
reporting, at the first communication device, a quality of service for the second communication device.

21. The method of claim 20 wherein the reporting further comprises providing, at the first communication device, a visual indication that characterizes the quality of service for the second communication device.

22. The method of claim 20, wherein the reporting further comprises providing, at the first communication device, an audio indication that characterizes the quality of service for the second communication device.

23. The method of claim 20, wherein the quality of service reported by at the first communication device indicates at least one of a signal strength, a signal to noise ratio, signal delay, data loss and echo level experienced by the second communication device.

24. The method of claim 20, wherein the information is a first information and the method further comprises:
providing, at the first communication device, a second information that characterizes quality of service for the first communication device; and
reporting, at the first communication device, the quality of service for the first communication device.

25. The method of claim 20, further comprising:
providing, at the second communication device, the first information;
analyzing, at the second communication device, the second information;
reporting, at the second communication device, a quality of service for the first communication device
receiving, at a base station, the first and second information; and
passing, at the base station, the first and second information to the second and first communication devices, respectively.

26. The method of claim 25 further comprising:
providing, from at least one of the first and second communication devices to the base station, information that indicates a physical location of at least one of the of the first and second communication devices; and
evaluating, at the base station, a quality of service for at least one of the first and second communication devices based on the first and second information and the information that indicates the physical location of the at least one of the first and second communication devices.
